(19) United States
(12) Patent Application Publication
(10) Pub. No.: US 2022/0123810 A1
(43) Pub. Date: Apr. 21, 2022

(54) CSI REPORT CONFIGURATION FOR FULL-DUPLEX COMMUNICATIONS

(71) Applicant: QUALCOMM Incorporated, San Diego, CA (US)

(72) Inventors: Min HUANG, Beijing (CN); Chao WEI, Beijing (CN); Yuwei REN, Beijing (CN)

(21) Appl. No.: 17/594,726

(22) PCT Filed: May 29, 2020
(86) PCT No.: PCT/CN2020/093157

§ 371 Date: Oct. 27, 2021

(30) Foreign Application Priority Data
May 31, 2019 (CN) PCT/CN2019/089435

(51) Int. Cl. H04B 7/06; H04L 5/00

(52) U.S. Cl. CPC H04B 7/0626; H04L 5/0048; H04L 5/14; H04L 5/0062; H04L 5/0091; H04L 5/0057

(57) ABSTRACT

Various aspects of the present disclosure generally relate to wireless communication. In some aspects, a user equipment (UE) may receive a dynamic indication of a transmission power difference between a reference signal and a downlink shared channel for a full-duplex zone. The UE may determine channel state information (CSI) based at least in part on the dynamic indication of the transmission power difference between the reference signal and the downlink shared channel for the full-duplex zone. The UE may transmit a CSI report that identifies the CSI. Numerous other aspects are provided.

### CROSS-REFERENCE TO RELATED APPLICATION

This Patent Application claims priority to PCT Patent Application No. PCT/CN2019/089435, filed on May 31, 2019, entitled “CSI REPORT CONFIGURATION FOR FULL-DUPLEX COMMUNICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel state information (CSI) report configuration for full-duplex (FD) communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, or the like, or a combination thereof). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, and even global level. New Radio (NR), which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements are applicable to other multiple access technologies and the telecommunication standards that employ these technologies.

In some radio access technologies (RATs), such as 5G/NR, full-duplex (FD) communication may be used to increase data rates and improve resource utilization. A wireless communication network equipment (such as a base station, among other possibilities) performing FD communication may transmit and receive contemporaneously on the same frequency band and in the same time slot, as contrasted with half-duplex communication, in which transmission and reception differ in time, frequency, or both time and frequency. The wireless communication network equipment may perform self-interference cancellation to cancel interference between a downlink transmission to a user equipment and an uplink reception from another user equipment. A time-frequency radio resource in which a wireless communication network equipment is performing FD communication may be referred to as an FD zone, and a time-frequency radio resource in which a wireless communication network equipment is not performing full-duplex communication may be referred to as a non-FD zone.

In some cases, a transmit power reduction may be applied in an FD zone relative to a non-FD zone. For example, a wireless communication network equipment may have a maximum allowable self-interference strength beyond which performance of the FD link may be unacceptably impacted. Thus, transmissions in an FD zone may be associated with a lower transmit power than transmissions in a non-FD zone. This may negatively impact performance of channel state information (CSI) determination and feedback, because the location of the CSI reference signal (CSI-RS) may be in a different type of zone (such as an FD zone or a non-FD zone) than a data channel associated with the CSI-RS, and because transmit power differences between the CSI-RS and the data channel may be statically configured. Thus, the CSI-RS may be associated with a different transmit power than the data channel due to the transmit power reduction being applied in the FD zone and not in the non-FD zone. Furthermore, in some cases, a single slot may contain FD zones and non-FD zones, and locations of FD zones and non-FD zones may vary on a per-slot or sub-slot granularity. Thus, static configuration of a transmit power reduction for an FD zone may be ineffective, particularly for a CSI-RS associated with a static transmit power difference relative to a corresponding data channel.

### SUMMARY

In some aspects, a method of wireless communication, performed by a user equipment (UE), may include receiving a dynamic indication of a transmission power difference between a reference signal and a downlink shared channel for a full-duplex zone; determining channel state information (CSI) based at least in part on the dynamic indication of the transmission power difference between the reference signal and the downlink shared channel for the full-duplex zone; and transmitting a CSI report that identifies the CSI.

In some aspects, a UE for wireless communication may include memory and one or more processors operatively coupled to the memory. The memory and the one or more processors may be configured to receive a dynamic indication of a transmission power difference between a reference signal and a downlink shared channel for a full-duplex zone; determine CSI based at least in part on the dynamic indication of the transmission power difference between the reference signal and the downlink shared channel for the full-duplex zone; and transmit a CSI report that identifies the CSI.

In some aspects, a method of wireless communication, performed by a base station, may include determining a transmission power difference between a reference signal and a downlink shared channel for a full-duplex zone; transmitting, to a UE, a dynamic indication of the transmission power difference; and receiving, from the UE, a CSI report that identifies CSI determined in accordance with the transmission power difference.

In some aspects, a base station for wireless communication may include memory and one or more processors operatively coupled to the memory. The memory and the one or more processors may be configured to determine a transmission power difference between a reference signal and a downlink shared channel for a full-duplex zone; transmit, to a UE, a dynamic indication of the transmission power difference; and receive, from the UE, a CSI report that identifies CSI determined in accordance with the transmission power difference.

In some aspects, a non-transitory computer-readable medium may store one or more instructions for wireless communication. The one or more instructions, when executed by one or more processors of a base station, may cause the one or more processors to: receive a dynamic indication of a transmission power difference between a reference signal and a downlink shared channel for a full-duplex zone; determine CSI based at least in part on the dynamic indication of the transmission power difference between the reference signal and the downlink shared channel for the full-duplex zone; and transmit a CSI report that identifies the CSI.

In some aspects, a non-transitory computer-readable medium may store one or more instructions for wireless communication. The one or more instructions, when executed by one or more processors of a base station, may cause the one or more processors to: determine a transmission power difference between a reference signal and a downlink shared channel for a full-duplex zone; transmit, to a UE, a dynamic indication of the transmission power difference; and receive, from the UE, a CSI report that identifies CSI determined in accordance with the transmission power difference.

In some aspects, an apparatus for wireless communication may include means for receiving a dynamic indication of a transmission power difference between a reference signal and a downlink shared channel for a full-duplex zone; means for determining CSI based at least in part on the dynamic indication of the transmission power difference between the reference signal and the downlink shared channel for the full-duplex zone; and means for transmitting a CSI report that identifies the CSI.

In some aspects, an apparatus for wireless communication may include means for determining a transmission power difference between a reference signal and a downlink shared channel for a full-duplex zone; means for transmitting, to a UE, a dynamic indication of the transmission power difference; and means for receiving, from the UE, a CSI report that identifies CSI determined in accordance with the transmission power difference.

Aspects generally include a method, apparatus, system, computer program product, non-transitory computer-readable medium, user equipment, base station, wireless communication device, and processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a block diagram illustrating an example wireless network in accordance with various aspects of the present disclosure.

FIG. 2 is a block diagram illustrating an example base station (BS) in communication with a user equipment (UE) in a wireless network in accordance with various aspects of the present disclosure.

FIG. 3 is a diagram illustrating an example of a base station performing full-duplex (FD) and non-FD communications in a slot in accordance with various aspects of the present disclosure.

FIG. 4 is a diagram illustrating an example of an integrated access and backhaul deployment in accordance with various aspects of the present disclosure.

FIG. 5 is a call flow diagram illustrating an example of communications between a base station, a downlink UE, and an uplink UE utilizing a dynamic indication of a transmission power difference in accordance with various aspects of the present disclosure.

FIG. 6 is a diagram illustrating an example process performed by a UE in accordance with various aspects of the present disclosure.

FIG. 7 is a diagram illustrating an example process performed by a base station in accordance with various aspects of the present disclosure.

FIG. 8 is a block diagram of an example apparatus for wireless communication.

FIG. 9 is a block diagram of an example apparatus for wireless communication.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like, or combinations thereof (collectively referred to as “elements”). These elements may be implemented using hardware, software, or combinations thereof. Whether such elements are implemented as hardware or software depends upon the particular application and design constraints imposed on the overall system.

It is noted that while aspects may be described herein using terminology commonly associated with 3G or 4G wireless technologies, aspects of the present disclosure can be applied in other generation-based communication systems, such as 5G and later, including NR technologies.

In some radio access technologies (RATs), such as 5G/NR, full-duplex (FD) communication may be used to increase data rates and improve resource utilization. A wireless communication network equipment performing FD communication may transmit and receive contemporaneously on the same frequency band and in the same time slot, as contrasted with half-duplex communication, in which transmission and reception differ in time, frequency, or both time and frequency. The wireless communication network equipment may perform self-interference cancellation to cancel interference between a downlink transmission of the wireless communication device and an uplink reception of the wireless communication device. A time in which a wireless communication network equipment is performing FD communication may be referred to as an FD zone and a time in which a wireless communication network equipment is not performing full-duplex communication may be referred to as a non-FD zone.

In some cases, a transmit power reduction may be applied in an FD zone relative to a non-FD zone. For example, a wireless communication network equipment may have a maximum allowable self-interference strength beyond which performance of the FD link may be unacceptably impacted. Thus, transmissions in an FD zone may be associated with a lower transmit power than transmissions in a non-FD zone. As an example, consider a base station that performs FD communication with a downlink UE and an uplink UE. In the downlink, the base station may transmit a signal to the downlink UE with a transmit power of Pₜₓ dB. In the uplink, the base station may receive a signal from the uplink UE with a receive power of Pᵣₓ dB. If the base station is capable of performing self-interference cancellation at a self-interference cancellation ratio of D dB, then the residual self-interference from the downlink to the uplink may be Pₜₓ−D. If the ratio between the received power and the residual self-interference is smaller than a desired signal-to-interference-plus-noise ratio (SINR), then reception performance of the uplink signal may be negatively impacted. The maximum allowable self-interference strength from downlink to uplink (denoted as I_{D2U}) may be determined as follows. If the target receiving power is configured as P₀ and the target receiving signal-to-noise ratio (SNR) is γ_{SNR}, then I_{D2U} may be approximately equal to P₀−γ_{SNR}. If a UE cannot realize the target receiving power, such as due to being at the cell edge, then I_{D2U} is not larger than the thermal noise power N₀. In such a case, the maximum allowable transmit power at the FD zone is equal to I_{D2U} plus the self-interference cancellation ratio of D.

As an example of the above procedure, in a non-FD zone, when the transmit power is Pₜₓ=43 dBm for M=100 physical resource blocks (PRBs), then the power spectrum density of the transmission may be Pₜₓ−10 log₁₀(M)=43−10*log₁₀(100)=23 dBm per PRB. In an FD zone, when the target receiving power is P₀=−90 dBm, the target receiving SNR is γ_{SNR}=10 dB, and the self-interference cancellation ratio is D=110 dB, then the maximum allowable transmit power spectrum density is I_{D2U}+D, which equals P₀−γ_{SNR}+D=−90−10+110=10 dBm per PRB. Thus, the transmit power reduction from the non-FD zone to the FD zone is 23−10=13 dB.

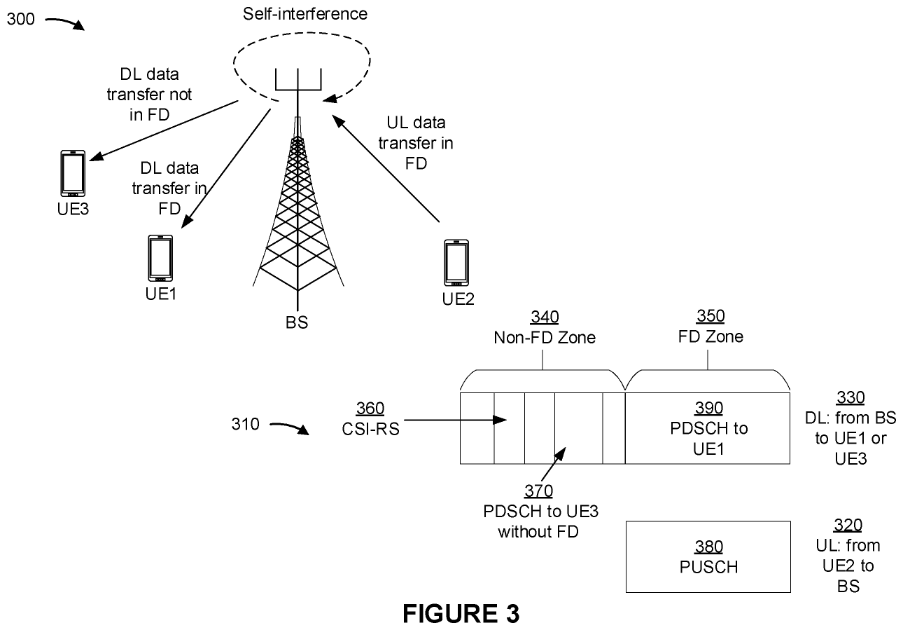

In some standards, the transmission power coefficient of a channel state information reference signal (CSI-RS) may be statically configured using a high-layer signal, such as a radio resource control (RRC) signal. The transmission power coefficient may indicate a ratio between CSI-RS transmission power and a physical downlink shared channel (PDSCH) transmission power. CSI for a PDSCH may be determined based at least in part on the transmission power coefficient and a CSI-RS corresponding to the PDSCH. The static configuration of the transmission power coefficient may negatively impact performance of CSI determination and feedback, because the location of the CSI-RS may be in a different type of zone (whether an FD zone or a non-FD zone) than a PDSCH associated with the CSI-RS. Thus, the CSI-RS may be associated with a different transmit power than the PDSCH due to the transmit power reduction being applied in the FD zone and not in the FD zone. Furthermore, in some cases, a single slot may contain FD zones and non-FD zones, and locations of FD zones and non-FD zones may vary on a per-slot or sub-slot granularity. For example, if the CSI-RS is statically configured for a non-FD zone, then the derived channel estimation result may have a higher amplitude than if the CSI-RS is statically configured for an FD zone, thereby reducing accuracy of channel estimation and leading to improper CSI in the FD zone. An example of the provision of a CSI-RS in a non-FD zone and a corresponding data channel in an FD zone is provided below in connection with FIG. 3.

In some aspects, the transmit power of a data channel, such as a PDSCH in an FD zone, may vary from slot to slot or at a sub-slot granularity. For example, the transmit power may be based at least in part on at least one of a downlink-to-uplink self-interference cancellation capability, an uplink received signal power, or a target uplink SINR. For example, the DL-to-UL self-interference cancellation may be based at least in part on a change of uplink receiving antenna beamforming vectors among other possibilities. The uplink received signal power may be based at least in part on an uplink pathloss, among other possibilities. The target uplink SINR may be based at least in part on an uplink data packet size, an uplink data channel transport format, an uplink data channel radio resource allocation, among other possibilities. These factors may lead to variation of a transmit power of the PDSCH in the FD zone on a slot-to-slot basis. Thus, the transmission power coefficient of the CSI-RS relative to the PDSCH (which indicates a ratio between CSI-RS transmission power and PDSCH transmission power used to determine CSI for the PDSCH) in the FD zone may be inefficient and inaccurate when configured using high-layer signaling (such as radio resource control (RRC) signaling), because high-layer reconfiguration may take several slots or tens of slots while the transmission power of the PDSCH in the FD zone may change on a slot-to-slot basis.

Some techniques and apparatuses described herein provide a dynamic indication of a transmit power difference between a CSI-RS and a corresponding PDSCH used to determine CSI for the PDSCH. For example, the dynamic indication may be provided using physical-layer signaling or media access control layer signaling, among other possibilities. The dynamic indication may provide for slot-to-slot reconfiguration of the transmit power difference between the CSI-RS and the PDSCH. In some aspects, a base station may configure multiple transmit power differences (e.g., multiple different ratios or differences between transmit power of a CSI-RS and a corresponding PDSCH) to be used by a UE to determine CSI for one or more PDSCHs. In such a case, the UE may report multiple CSI that are determined using each transmit power difference of the multiple transmit power differences. This may improve flexibility of scheduling by the base station. For example, the base station may selectively pair the downlink UE with an uplink UE based at least in part on the transmit power difference and an uplink SINR of the uplink UE. These techniques can be applied in a variety of FD deployments, such as an FD cell provided by a base station, an integrated access and backhaul (IAB) deployment (such as a single-hop IAB deployment or a multi-hop IAB deployment), among other possibilities.

In this way, a method for a UE to report CSI based at least in part on a transmission power difference between a CSI-RS and an FD PDSCH is provided, which increases the accuracy of the CSI report in FD communication. Accordingly, a more suitable transport format can be selected, and thus transfer reliability in FD can be improved. Furthermore, the diminished likelihood of transfer failure also leads to higher UE throughput.

Still further, a base station may flexibly configure CSI reports with multiple transmission power differences for a downlink UE. In this way, the base station can determine the impacts on the downlink UE when different downlink transmission powers are utilized (such as when different uplink UEs are scheduled). This information can help the base station achieve better scheduling results, such as higher system throughput, higher transfer reliability, higher system robustness, and shorter transfer latency.

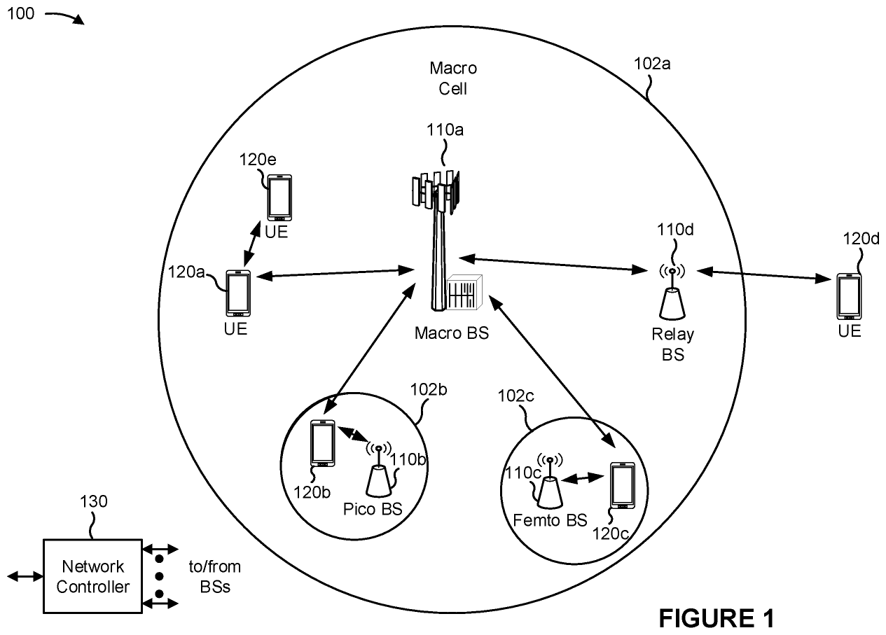

FIG. 1 is a block diagram illustrating an example wireless network 100 in accordance with various aspects of the present disclosure. The wireless network 100 may be a Long Term Evolution (LTE) network or some other wireless network, such as a 5G or NR network. The wireless network 100 may include a quantity of base stations (BSs) 110 (shown as BS 110a, BS 110b, BS 110c, and BS 110d) and other network entities. A BS is an entity that communicates with user equipment (UE(s)) and may also be referred to as a Node B, an eNodeB, an eNB, a gNB, a NR BS, a 5G node B (NB), an access point (AP), a transmit receive point (TRP), or the like, or combinations thereof (these terms are used interchangeably herein). Each BS may provide communication coverage for a particular geographic area. In 3GPP, the term “cell” can refer to a coverage area of a BS or a BS subsystem serving this coverage area, depending on the context in which the term is used.

ABS may provide communication coverage for a macro cell, a pico cell, a femto cell, or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). ABS for a macro cell may be referred to as a macro BS. A BS for a pico cell may be referred to as a pico BS. ABS for a femto cell may be referred to as a femto BS or a home BS. ABS may support one or multiple (for example, three) cells.

Wireless network 100 may be a heterogeneous network that includes BSs of different types, for example, macro BSs, pico BSs, femto BSs, relay BSs, or the like, or combinations thereof. These different types of BSs may have different transmit power levels, different coverage areas, and different impacts on interference in wireless network 100. For example, macro BSs may have a high transmit power level (for example, 5 to 40 watts) whereas pico BSs, femto BSs, and relay BSs may have lower transmit power levels (for example, 0.1 to 2 watts). In the example shown in FIG. 1, a BS 110a may be a macro BS for a macro cell 102a, a BS 110b may be a pico BS for a pico cell 102b, and a BS 110c may be a femto BS for a femto cell 102c. A network controller 130 may couple to the set of BSs 102a, 102b, 110a and 110b, and may provide coordination and control for these BSs. Network controller 130 may communicate with the BSs via a backhaul. The BSs may also communicate with one another, for example, directly or indirectly via a wireless or wireline backhaul.

In some aspects, a cell may not be stationary, rather, the geographic area of the cell may move in accordance with the location of a mobile BS. In some aspects, the BSs may be interconnected to one another or to one or more other BSs or network nodes (not shown) in the wireless network 100 through various types of backhaul interfaces such as a direct physical connection, a virtual network, or the like, or combinations thereof using any suitable transport network.

Wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, or the like, or combinations thereof.

UEs 120 (for example, 120a, 120b, 120c) may be dispersed throughout wireless network 100, and each UE may be stationary or mobile. A UE may also be referred to as an access terminal, a terminal, a mobile station, a subscriber unit, a station, or the like, or combinations thereof. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, or the like, or combinations thereof, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, or may be implemented as NB-IoT (narrowband internet of things) devices. Some UEs may be considered a Customer Premises Equipment (CPE). UE 120 may be included inside a housing that houses components of UE 120, such as processor components, memory components, or the like, or combinations thereof.

In general, any quantity of wireless networks may be deployed in a given geographic area. Each wireless network may support a particular radio access technology (RAT) and may operate on one or more frequencies or frequency channels. A frequency may also be referred to as a carrier or the like, or combinations thereof. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly with one another using one or more sidelink channels (for example, without using a base station 110 as an intermediary). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or the like, or combinations thereof), a mesh network, or the like, or combinations thereof. In this case, the UE 120 may perform scheduling operations, resource selection operations, or other operations described elsewhere herein as being performed by the base station 110.

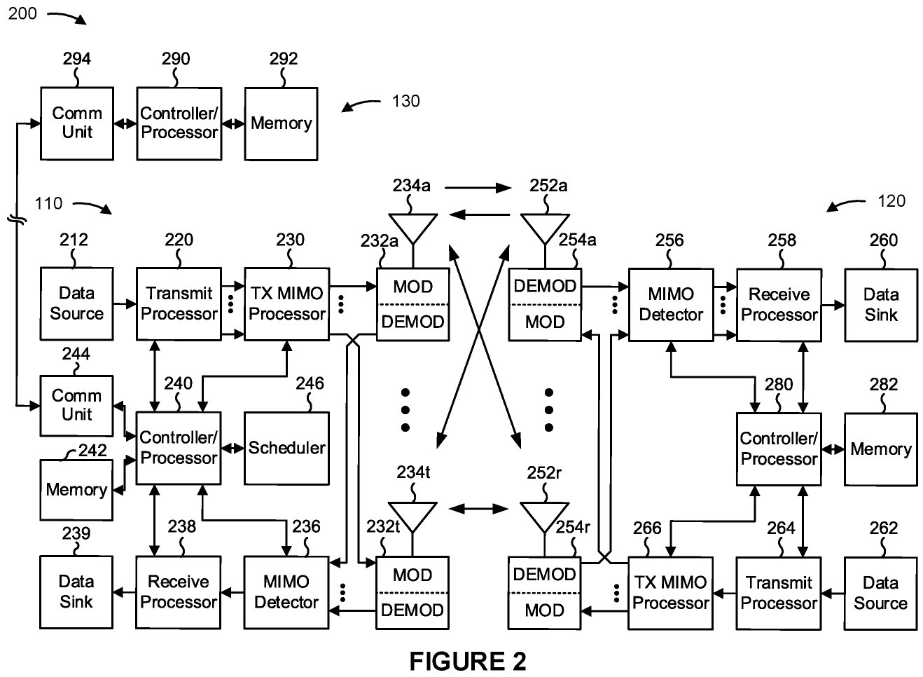

FIG. 2 is a block diagram 200 illustrating an example base station (BS) in communication with a user equipment (UE) in a wireless network in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCSs) for each UE based at least in part on channel quality indicators (CQIs) received from the UE, process (for example, encode) the data for each UE based at least in part on the MCS(s) selected for the UE, and provide data symbols for all UEs. Transmit processor 220 may also process system information (for example, for semi-static resource partitioning information (SRPI) or the like, or combinations thereof) and control information (for example, CQI requests, grants, upper layer signaling, or the like, or combinations thereof) and provide overhead symbols and control symbols. Transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each MOD 232 may process a respective output symbol stream (for example, for OFDM or the like, or combinations thereof) to obtain an output sample stream. Each MOD 232 may further process (for example, convert to analog, amplify, filter, and upconvert) the output sample stream to obtain a downlink signal. T downlink signals from MODs 232a through 232t may be transmitted via T antennas 234a through 234t, respectively. In accordance with various aspects described in more detail below, the synchronization signals can be generated with location encoding to convey additional information.

At UE 120, antennas 252a through 252r may receive the downlink signals from base station 110 or other base stations and may provide received signals to R demodulators (DEMODs) 254a through 254r, respectively. Each DEMOD 254 may condition (for example, filter, amplify, downconvert, and digitize) a received signal to obtain input samples. Each DEMOD 254 may further process the input samples (for example, for OFDM or the like, or combinations thereof) to obtain received symbols. A MIMO detector 256 may obtain received symbols from all R DEMODs 254a through 254r, perform MIMO detection on the received symbols if applicable, and provide detected symbols. A receive processor 258 may process (for example, decode) the detected symbols, provide decoded data for UE 120 to a data sink 260, and provide decoded control information and system information to a controller/processor 280. A channel processor may determine a reference signal received power (RSRP), a received signal strength indicator (RSSI), a reference signal received quality (RSRQ), a channel quality indicator (CQI), or the like, or combinations thereof. In some aspects, one or more components of UE 120 may be included in a housing.

On the uplink, at UE 120, a transmit processor 264 may receive and process data from a data source 262 as well as control information (for example, for reports including RSRP, RSSI, RSRQ, CQI, or the like, or combinations thereof) from controller/processor 280. Transmit processor 264 may also generate reference symbols for one or more reference signals. The symbols from transmit processor 264 may be precoded by a TX MIMO processor 266 if applicable, further processed by MODs 254a through 254r (for example, for discrete Fourier transform spread orthogonal frequency division multiplexing (DFT-s-OFDM), orthogonal frequency division multiplexing (OFDM) with a cyclic prefix (CP) (CP-OFDM), or the like, or combinations thereof), and transmitted to base station 110. At base station 110, the uplink signals from UE 120 and other UEs may be received by antennas 234, processed by DEMODs 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

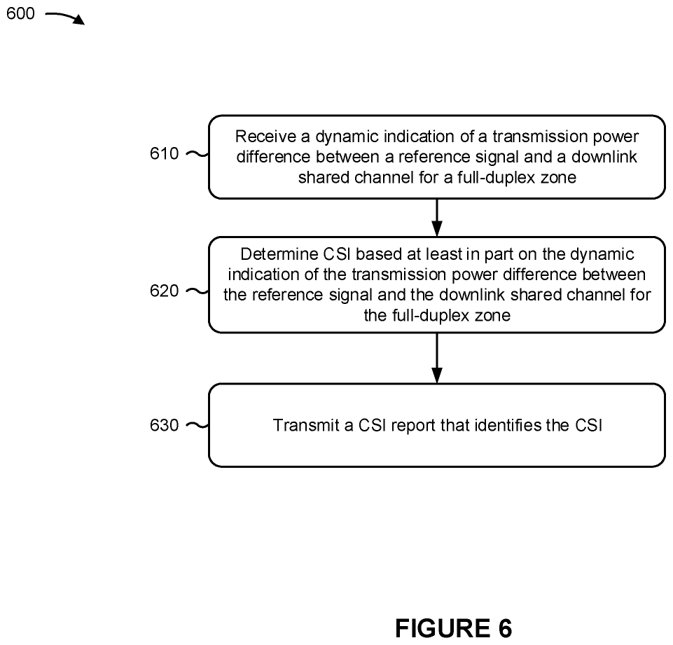

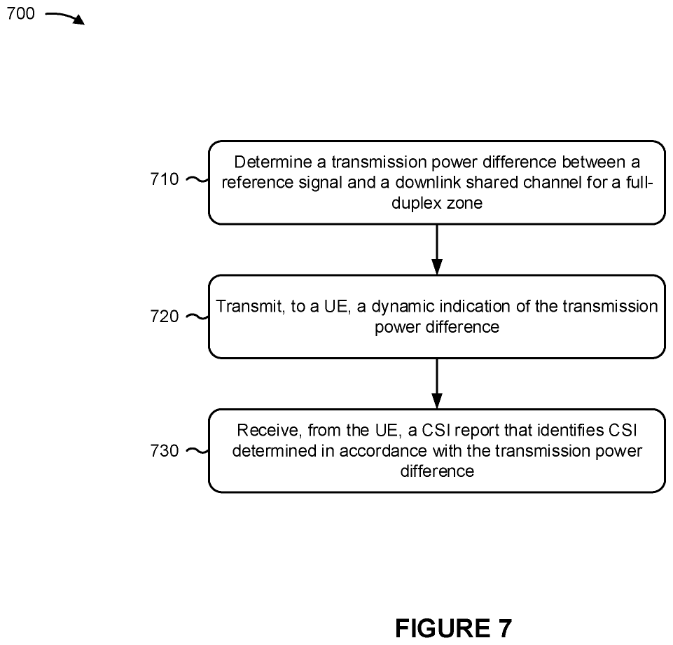

Controller/processor 240 of base station 110, controller/processor 280 of UE 120, or any other component(s) of FIG. 2 may perform one or more techniques associated with channel state information (CSI) report configuration for full-duplex communications, as described in more detail elsewhere herein. For example, controller/processor 240 of base station 110, controller/processor 280 of UE 120, or any other component(s) of FIG. 2 may perform or direct operations of, for example, process 600 of FIG. 6, process 700 of FIG. 7, or other processes as described herein. Memories 242 and 282 may store data and program codes for base station 110 and UE 120, respectively. A scheduler 246 may schedule UEs for data transmission on the downlink or uplink.

In some aspects, UE 120 may include means for receiving a dynamic indication of a transmission power difference between a reference signal and a downlink shared channel for a full-duplex zone; means for determining CSI based at least in part on the dynamic indication of the transmission power difference between the reference signal and the downlink shared channel for the full-duplex zone; means for transmitting a CSI report that identifies the CSI; means for receiving dynamic indications of a plurality of transmission power differences, where the plurality of transmission power differences include the transmission power difference, and where the plurality of transmission power differences correspond to respective downlink transmission powers; means for determining the CSI in accordance with at least; means for receiving high-layer signaling identifying a plurality of transmission power differences, where the dynamic indication indicates which transmission power difference, of the plurality of transmission power differences, is to be used to determine the CSI; or the like, or combinations thereof. In some aspects, such means may include one or more components of UE 120 described in connection with FIG. 2.

In some aspects, base station 110 may include means for determining a transmission power difference between a reference signal and a downlink shared channel for a full-duplex zone; means for transmitting, to a UE, a dynamic indication of the transmission power difference; means for receiving, from the UE, a CSI report that identifies CSI determined in accordance with the transmission power difference; means for transmitting dynamic indications of a plurality of transmission power differences, where the plurality of transmission power differences include the transmission power difference, and where the plurality of transmission power differences correspond to respective downlink transmission powers; means for scheduling an uplink communication of a particular UE, of the plurality of UEs, and a downlink communication of the UE in the full-duplex zone based at least in part on CSI associated with a transmission power difference, of the plurality of transmission power differences, corresponding to the UE; means for transmitting high-layer signaling identifying a plurality of transmission power differences, where the dynamic indication indicates which transmission power difference, of the plurality of transmission power differences, is to be used to determine the CSI; or the like, or combinations thereof In some aspects, such means may include one or more components of base station 110 described in connection with FIG. 2.

FIG. 3 is a diagram illustrating an example 300 of a base station performing FD and non-FD communications in a slot, in accordance with various aspects of the present disclosure. As shown, FIG. 3 includes a BS (such as BS 110) communicating with three UEs (such as UE 120): UE1, UE2, and UE3. UE1 and UE3 may be referred to as downlink UEs, because UE1 and UE3 are associated with downlink data transfers from the BS. UE2 may be referred to as an uplink UE, because UE2 is associated with an uplink data transfer to the BS.

FIG. 3 additionally shows an example of resource allocations in a slot 310 for communications between the BS and the three UEs of example 300. Uplink communications to the BS are indicated by reference number 320, and downlink communications from the BS are indicated by reference number 330. The uplink and downlink communications indicated by reference numbers 320 and 330 may at least partially overlap in frequency or may not overlap in frequency. As shown, the slot 310 may include a non-FD zone 340 and an FD zone 350. In the non-FD zone 340, half-duplex communications may be transmitted or received. For example, the BS transmits a CSI-RS 360 to UE1 and UE3, and the BS transmits a PDSCH 370 to UE3 in the non-FD zone. In the FD zone 350, the BS receives a PUSCH 380 from UE2 and transmits a PDSCH 390 to UE1. The BS may be associated with a different downlink transmit power for the PDSCH 370 than the PDSCH 390, because the PDSCH 370 is in a non-FD zone and the PDSCH 390 is in an FD zone. Furthermore, a CSI report configuration of the CSI-RS 360 may identify a transmit power difference between the CSI-RS 360 and a corresponding PDSCH (PDSCH 370 or PDSCH 390). However, the difference in transmit power between the PDSCH 370 and the PDSCH 390 may lead to sub-optimal scheduling, because the CSI-RS 360 is shared between PDSCHs in the non-FD zone and in the FD zone. Some techniques and apparatuses described herein provide dynamic signaling of a transmit power difference between a CSI-RS and a corresponding PDSCH (such as at a slot granularity) so that the difference between the CSI-RS 360 and each of the PDSCHs 370 and 390 can be signaled. This also allows for adaptation of the transmit power difference from slot to slot, because the FD zone and the non-FD zone may change in time location or frequency location from slot to slot.

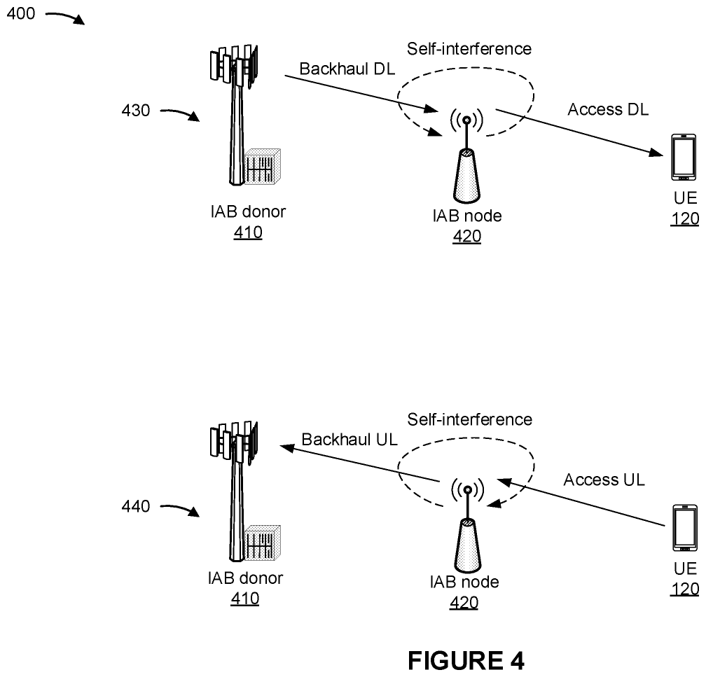

FIG. 4 is a diagram illustrating an example of an integrated access and backhaul (IAB) deployment 400 in which the techniques and apparatuses described herein may be implemented. As shown, the IAB deployment 400 includes an IAB donor 410, an IAB node 420, and a UE 120. The IAB donor 410 and the IAB node 420 may be BSs 110 or may include one or more components of BS 110, which are described elsewhere herein.

As shown, in a first case 430, the IAB node 420 may experience self-interference in downlink communications, such as a downlink communication from the IAB donor 410 to the UE 120 via the IAB node 420. In this case, the self-interference may occur between the backhaul downlink communication received from the IAB donor 410 and the access downlink communication transmitted to the UE 120. In a second case 440, the IAB node 420 may experience self-interference in uplink communications, such as an uplink communication from the UE 120 to the IAB donor 410 via the IAB node 420. In this case, the self-interference may occur between the access uplink communication received from the UE 120 and the backhaul uplink communication transmitted to the IAB donor 410. The issues described in connection with FIG. 3, such as disparity between transmit power between different PDSCHs in FD zones and non-FD zones, may also apply with regard to example 400. The dynamic signaling of the transmit power difference, described below, may mitigate or negate the impact of the disparity of transmit power, thereby improving performance of the IAB deployment.

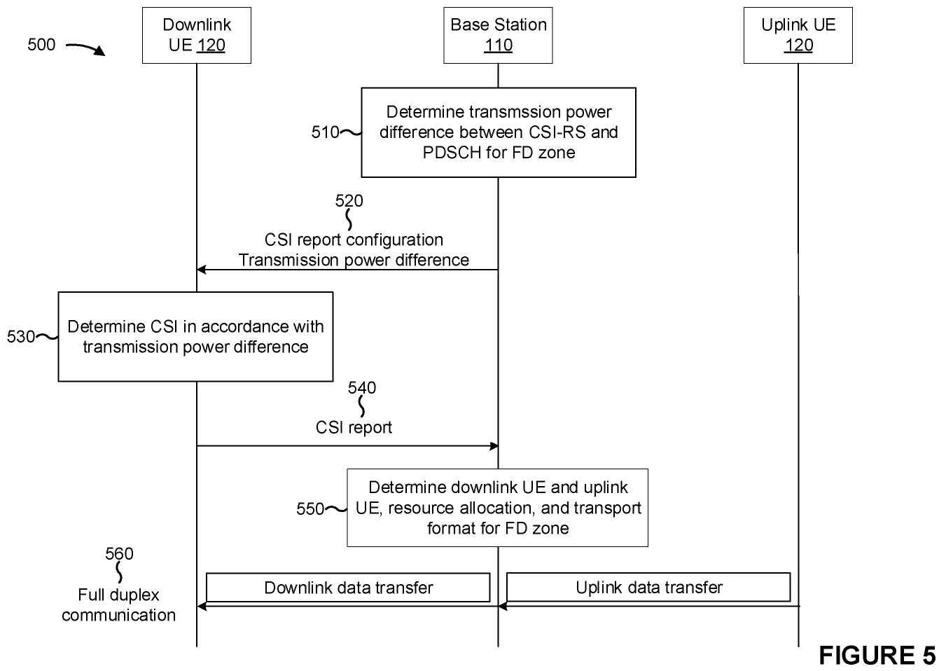

FIG. 5 shows a diagram illustrating an example call flow 500 between a base station, a downlink UE, and an uplink UE utilizing a dynamic indication of a transmission power difference, in accordance with various aspects of the present disclosure. Example 500 includes an uplink UE 120, a downlink UE 120, and a base station 110 (referred to hereinafter as a BS 110). The uplink UE 120 and the downlink UE 120 can each represent multiple UEs. For example, the uplink UE 120 can represent multiple UEs 120 that transmit data to the BS 110, and the downlink UE 120 can represent multiple UEs 120 that are configured to perform CSI reporting and receive data from the BS 110.

As shown by reference number 510, the BS 110 may determine a transmission power difference between a CSI-RS and a PDSCH for an FD zone. In some aspects, the transmission power difference may be referred to as P_{diff}. The transmission power difference may identify a difference in a transmission power between a CSI-RS and a corresponding PDSCH, and may be communicated using a CSI report configuration for the CSI-RS or another form of dynamic signaling, as described below. In some aspects, the transmission power difference may be between a CSI-RS in a non-FD zone and a PDSCH in an FD zone. In some aspects, the transmission power difference may be between a CSI-RS and a PDSCH in a non-FD zone. In some aspects, the transmission power difference may be between a CSI-RS in an FD zone and a PDSCH in a non-FD zone.

The BS 110 may determine the transmission power difference based at least in part on at least one of a received uplink signal power (such as a signal power measurement associated with an uplink signal from the uplink UE 120), a target uplink SINR, a downlink-to-uplink self-interference cancellation ratio, among other possibilities. For example, if the uplink received signal power is P_{Rx,UL} per physical resource block (PRB), the target uplink SINR is γ_{SINR}, and the downlink-to-uplink self-interference cancellation ratio is D, then the downlink transmission power per PRB in the FD zone may be equal to P_{Tx,DL,FD}=P_{Rx,UL}−γ_{SINR}−D. Taking into account the CSI-RS transmission power per PRB in the non-FD zone (denoted as P_{Tx,CSI-RS,non-FD}), the transmission power difference between the CSI-RS and the PDSCH for the FD zone may be equal to P_{Tx,CSI-RS,non-FD}−P_{Tx,DL,FD} (dB). In this case, the BS 110 can determine the uplink received signal power P_{Rx,UL} based at least in part on the uplink pathloss (or power headroom report (PHR)) and physical uplink shared channel (PUSCH) frequency-domain bandwidth (such as according to an uplink power control related procedure defined in a wireless communication standard such as the LTE/NR standard).

In some aspects, the BS 110 may determine the uplink target SINR γ_{SINR} on a per-requirement basis. For example, the BS 110 may determine γ_{SINR} to be large enough so that the PUSCH can accommodate all buffered uplink data within a given uplink radio resource. With the same uplink radio resource, the BS 110 may determine a higher uplink SINR when more signal data is in the buffer. The downlink-to-uplink self-interference cancellation ratio D may be a parameter of an FD node (such as the BS 110) that is based at least in part on the FD node's ability to cancel self-interference. D may vary for different transmitting and receiving beams. For example, the more a receive beam lies in the null space of a transmitting beam, the more the downlink-to-uplink self-interference cancellation ratio may increase.

In some aspects, the BS 110 may determine multiple P_{diff} values for a downlink UE 120. For example, the BS 110 may determine multiple P_{diff} values for different PDSCH transmission powers. This may enable the BS 110 to select an uplink UE 120 with which to pair the downlink UE 120 based at least in part on SINR requirements of the uplink UE 120. For example, if the BS 110 is to pair a downlink UE 120 with an uplink UE 120 that requires a higher uplink SINR, then the BS 110 may determine a P_{diff} value associated with a lower downlink transmission power, or may use the CSI report associated with the CSI corresponding to the P_{diff} associated with the lower downlink transmission power. In some aspects, each CSI-RS resource may be associated with one P_{diff} value, and the corresponding P_{diff} value may be used to determine CSI for a particular CSI-RS resource. In some aspects, a CSI-RS resource may be associated with multiple P_{diff} values. In such a case, the BS 110 may indicate which P_{diff} value is to be used, as described in more detail elsewhere herein.

As shown by reference number 520, the BS 110 may provide a CSI report configuration to the downlink UE 120. The CSI report configuration may include information identifying the transmission power difference P_{diff}. In some aspects, the CSI report configuration may pertain to a non-FD zone. In such a case, P_{diff} may be equal to a static transmission power difference value, such as the value configured by an RRC-layer message. When the CSI report configuration pertains to an FD zone, P_{diff} can be smaller than, equal to, or larger than the static transmission power difference value. In many cases, because the downlink transmission power is reduced in FD zone, P_{diff}=P_{Tx,CSI-RS,non-FD}−P_{Tx,DL,FD} may be larger than the static transmission power difference value. In some aspects, the BS 110 may provide the value of P_{diff} for the FD zone using a dynamic indication, such as a physical-layer message, a media access control (MAC) control element (CE), or downlink control information (DCI).

In some aspects, P_{diff} can be indicated by a MAC CE, a physical-layer DCI, or a high-layer message (such as a radio resource control (RRC) message) depending on the type of CSI report to be provided by the downlink UE 120. For example, if the CSI report is a periodic CSI report, then the configuration of P_{diff} may use a high-layer (such as RRC layer) message. If the CSI report is a semi-persistent or aperiodic CSI report, the configuration of P_{diff} may use a high-layer message, a MAC CE, DCI, or a combination thereof. For example, for a semi-persistent CSI report, the BS 110 may provide a list of CSI reports with different P_{diff} values using a high-layer message, and then the activation or deactivation of one or more of the P_{diff} values is indicated using a dynamic indication, such as a MAC CE or DCI. As another example, for an aperiodic CSI report, the BS 110 may provide a list of different P_{diff} values using a high-layer message, and then one or more selected P_{diff} values for an aperiodic CSI report may be indicated by MAC CE or DCI (such as the DCI used to trigger an aperiodic CSI report). In this case, the DCI may include an indicator such as a codepoint whose value indicates an index of the selected P_{diff} value. In some aspects, the BS 110 may transmit a group-common DCI that is addressed to a particular radio network temporary identifier (RNTI). The group-common DCI may indicate P_{diff} for a set of UEs 120 associated with the particular RNTI. In some aspects, the group-common DCI may include multiple P_{diff} values, each of which may relate to a CSI report configuration. The BS 110 may transmit the group-common DCI in a control channel, such as a physical downlink control channel (PDCCH). The set of UEs 120 associated with the particular RNTI may receive the group-common DCI and update P_{diff} values for corresponding CSI reports in accordance with the group-common DCI. When the BS 110 provides multiple values of P_{diff}, each P_{diff} value may be associated with a respective CSI configuration. For example, a P_{diff} value 1 may be associated with a first CSI configuration, a P_{diff} value 2 may be associated with a second CSI configuration, and so on.

As shown by reference number 530, the downlink UE 120 may determine CSI in accordance with the transmission power difference. For example, the downlink UE 120 may determine the CSI by performing channel estimation based at least in part on a received PDSCH transmission power information for the FD zone (such as P_{diff}). When the channel estimation result using a CSI-RS in a non-FD zone has a power P_{channel}, then the downlink UE 120 may determine CSI using P_{channel}−P_{diff} for the FD zone, thereby taking into account the transmission power difference between a CSI-RS in a non-FD zone and a PDSCH in an FD zone. Generally, with a smaller downlink transmission power, the generated rank indicator (RI) and channel quality indicator (CQI) of the CSI may be smaller.

In some aspects, multiple P_{diff} values are configured. In some aspects, if one CSI-RS resource is associated with only one P_{diff} value, then the CSI report may indicate which P_{diff} value was used to determine the CSI. For example, a CSI-RS Resource Indicator (CRI) of the CSI report may indicate which P_{diff} value was used to determine the CSI. If one CSI-RS resource is associated with multiple P_{diff} values, then the CSI report may include an indicator of which P_{diff} value is used to determine the CSI. This indicator may be referred to as a transmission power indicator (TPI). For example, the TPI may indicate an index of a P_{diff} value used to determine the CSI, from multiple P_{diff} values associated with the CSI-RS resource.

In some aspects, uplink control channel resources may be limited. In some aspects, the uplink UE 120 may use a priority rule to prioritize CSIs with different P_{diff} values. In such a case, CSI reports with lower priority levels are dropped if uplink control channel resources are scarce or unavailable. As one example, the sequence of multiple P_{diff} values in the CSI report configuration message may be used as the priority order. As a second example, a CSI report with P_{diff} equal to the static value configured in RRC message may have the highest priority, and a CSI report with a larger P_{diff} value may have a lower priority.

As shown by reference number 540, the downlink UE 120 may provide a CSI report to the BS 110. For example, the UE 120 may transmit a CSI report identifying the CSI determined in accordance with the operations described in connection with reference number 530, above. In some aspects, the CSI report may include a respective CSI report for each CSI-RS resource for which the downlink UE 120 determined CSI (in other words, a one-to-one mapping between CSI-RS resources and corresponding CSI reports). In some aspects, the UE 120 may provide multiple CSI reports for a CSI-RS, and each CSI report may be associated with a different P_{diff} value for the CSI-RS.

As shown by reference number 550, the BS 110 may schedule communications based at least in part on the CSI report. For example, the BS 110 may determine a downlink UE 120 and an uplink UE 120 to be paired for FD communication, a resource allocation for an FD communication, or a transport format for an FD zone, among other possibilities. When the BS 110 configures multiple P_{diff} values for a downlink UE 120, the downlink UE 120 may report CSIs for different downlink transmission powers. Which of these CSIs is used to determine downlink transport format (such as a modulation and coding scheme (MCS) among other possibilities) may depend on scheduling by the BS 110. For example, if a BS 110 determines that the downlink UE 120 is to be paired with an uplink UE 120 that requires a higher uplink SINR, then the BS 110 may use a CSI with a lower downlink transmission power. As shown by reference number 560, the BS 110 may perform FD communication with the downlink UE 120 and the uplink UE 120 in accordance with the scheduling information described above.

In some aspects, the BS 110 may pair downlink UEs 120 and uplink UEs 120 for full-duplex communication. For example, in a cell with a high traffic load that includes uplink and downlink communications, the BS 110 may need to select UEs (for the purpose of this example, one downlink UE 120 and three uplink UEs 120) to carry out downlink or uplink data transfer in FD, and may determine transport formats for the four UEs. The BS 110 may use different receiving antenna beamforming vectors to receive the uplink signals from a first uplink UE 120, a second uplink UE 120, and a third uplink UE 120, so the downlink-to-uplink self-interference cancellation ratios (D) are different when these uplink UEs 120 are scheduled in full duplex communication. According to the different D values of the uplink UEs 120, the BS 110 may determine three transmission power differences P_{diff}. The BS 110 may transmit a message to a downlink UE 120 indicating the CSI report configuration including the three P_{diff} values. In this case, the three P_{diff} values may be associated with the same CSI-RS resource. The downlink UE 120 may determine CSIs for each P_{diff} value. The downlink UE 120 may provide one or more CSI reports indicating the CSIs to the BS 110. These CSIs may include or indicate the corresponding index of the P_{diff} values used to determine the CSI (such as using the TPI defined above). The BS 110 may select one of these CSIs according to which uplink UE 120 is scheduled with the downlink UE 120 in a current slot. For example, the BS 110 may select a first CSI report to generate a PDSCH in a slot in which FD communication is to be performed with the first uplink UE 120, a second CSI report to generate a PDSCH in another slot in which FD communication is to be performed with the second uplink UE 120, and so on. Such scheduling can be performed on a per-slot basis, resulting in different uplink UE selection in each slot.

FIG. 6 is a diagram illustrating an example process 600 performed, for example, by a user equipment, in accordance with various aspects of the present disclosure. Example process 600 is an example where a UE (user equipment 120 among other possibilities) performs operations associated with CSI reporting using a transmission power difference.

As shown in FIG. 6, in some aspects, process 600 may include receiving a dynamic indication of a transmission power difference between a reference signal and a downlink shared channel for a full-duplex zone (block 610). For example, the UE (such as using antenna 252, DEMOD 254, MIMO detector 256, receive processor 258, controller/processor 280, among other possibilities) may receive a dynamic indication of a transmission power difference between a reference signal and a downlink shared channel for a full-duplex zone, as described above.

As further shown in FIG. 6, in some aspects, process 600 may include determining CSI based at least in part on the dynamic indication of the transmission power difference between the reference signal and the downlink shared channel for the full-duplex zone (block 620). For example, the UE (such as using antenna 252, DEMOD 254, MIMO detector 256, receive processor 258, controller/processor 280, among other possibilities) may determine CSI based at least in part on the dynamic indication of the transmission power difference between the reference signal and the downlink shared channel for the full-duplex zone, as described above.

As further shown in FIG. 6, in some aspects, process 600 may include transmitting a CSI report that identifies the CSI (block 630). For example, the UE (such as using controller/processor 280, transmit processor 264, TX MIMO processor 266, MOD 254, antenna 252, among other possibilities) may transmit a CSI report that identifies the CSI, as described above.

Process 600 may include additional aspects, such as any single aspect or any combination of aspects described below or in connection with one or more other processes described elsewhere herein.

In a first aspect, the reference signal is a CSI reference signal.

In a second aspect, alone or in combination with the first aspect, the dynamic indication is included in a CSI report configuration.

In a third aspect, alone or in combination with one or more of the first and second aspects, the dynamic indication is based at least in part on at least one of: an uplink received signal power, a target uplink signal-to-interference-and-noise ratio, a self-interference cancellation ratio, a reference signal transmission power in a non-full-duplex zone, or a combination thereof.

In a fourth aspect, alone or in combination with one or more of the first through third aspects, when the transmission power difference pertains to a non-full-duplex zone, the transmission power difference has a value of a static transmission power difference value.

In a fifth aspect, alone or in combination with one or more of the first through fourth aspects, the UE may receive dynamic indications of a plurality of transmission power differences. In some aspects, the plurality of transmission power differences include the transmission power difference. In some aspects, the plurality of transmission power differences correspond to respective downlink transmission powers. In some aspects, determining the CSI further includes determining the CSI in accordance with at least one transmission power difference of the plurality of transmission power differences.

In a sixth aspect, alone or in combination with one or more of the first through fifth aspects, each transmission power difference, of the plurality of transmission power differences, is associated with a respective reference signal resource.

In a seventh aspect, alone or in combination with one or more of the first through sixth aspects, the plurality of transmission power differences are associated with a single reference signal resource.

In an eighth aspect, alone or in combination with one or more of the first through seventh aspects, one or more first transmission power differences, of the plurality of transmission power differences, are mapped to a single reference signal resource. In some aspects, one or more second transmission power differences, of the plurality of transmission power differences, are mapped to one or more respective reference signal resources.

In a ninth aspect, alone or in combination with one or more of the first through eighth aspects, the CSI report includes a CSI reference signal resource indicator (CRI) which indicates the transmission power difference used to determine the CSI on a reference signal resource associated with the CSI.

In a tenth aspect, alone or in combination with one or more of the first through ninth aspects, the CSI report includes an indicator of the transmission power difference, of the plurality of transmission power differences associated with the reference signal resource, used to determine the CSI on the reference signal resource.

In an eleventh aspect, alone or in combination with one or more of the first through tenth aspects, an order of the plurality of transmission power differences in the dynamic indications indicates priorities of CSI reports corresponding to the plurality of transmission power differences.

In a twelfth aspect, alone or in combination with one or more of the first through eleventh aspects, magnitudes of the plurality of transmission power differences indicate priorities of CSI reports corresponding to the plurality of transmission power differences.

In a thirteenth aspect, alone or in combination with one or more of the first through twelfth aspects, the dynamic indication includes at least one of: a media access control (MAC) control element (CE), downlink control information (DCI), or a combination thereof.

In a fourteenth aspect, alone or in combination with one or more of the first through thirteenth aspects, the UE may receive high-layer signaling identifying a plurality of transmission power differences. In some aspects, the dynamic indication indicates which transmission power difference, of the plurality of transmission power differences, is to be used to determine the CSI.

In a fifteenth aspect, alone or in combination with one or more of the first through fourteenth aspects, the dynamic indication is associated with or included in downlink control information that triggers the determination of the CSI or transmission of the CSI report.

In a sixteenth aspect, alone or in combination with one or more of the first through fifteenth aspects, the dynamic indication is included in group-common DCI that is addressed to a radio network temporary identifier (RNTI) associated with the UE.

In a seventeenth aspect, alone or in combination with one or more of the first through sixteenth aspects, the group-common DCI includes a plurality of dynamic indications for a plurality of UEs associated with the RNTI.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where a base station (such as base station 110 among other possibilities) performs operations associated with scheduling based at least in part on CSI reporting in accordance with a transmission power difference.

As shown in FIG. 7, in some aspects, process 700 may include determining a transmission power difference between a reference signal and a downlink shared channel for a full-duplex zone (block 710). For example, the base station (such as using antenna 234, DEMOD 232, MIMO detector 236, receive processor 238, controller/processor 240, among other possibilities) may determine a transmission power difference between a reference signal and a downlink shared channel for a full-duplex zone, as described above.

As further shown in FIG. 7, in some aspects, process 700 may include transmitting, to a UE, a dynamic indication of the transmission power difference (block 720). For example, the base station (such as using controller/processor 240, transmit processor 220, TX MIMO processor 230, MOD 232, antenna 234, among other possibilities) may transmit, to a UE, a dynamic indication of the transmission power difference, as described above.

As further shown in FIG. 7, in some aspects, process 700 may include receiving, from the UE, a CSI report that identifies CSI determined in accordance with the transmission power difference (block 730). For example, the base station (such as using antenna 234, DEMOD 232, MIMO detector 236, receive processor 238, controller/processor 240, among other possibilities) may receive, from the UE, a CSI report that identifies CSI determined in accordance with the transmission power difference, as described above.

Process 700 may include additional aspects, such as any single aspect or any combination of aspects described below or in connection with one or more other processes described elsewhere herein.

In a first aspect, the base station may transmit dynamic indications of a plurality of transmission power differences, where the plurality of transmission power differences include the transmission power difference, where the plurality of transmission power differences correspond to respective downlink transmission powers, and where the CSI report includes CSI for the plurality of transmission power differences.

In a second aspect, alone or in combination with the first aspect, the plurality of transmission power differences correspond to respective uplink communications of a plurality of UEs.

In a third aspect, alone or in combination with one or more of the first and second aspects, the base station may schedule an uplink communication of a particular UE, of the plurality of UEs, and a downlink communication of the UE in the full-duplex zone based at least in part on CSI associated with a transmission power difference, of the plurality of transmission power differences, corresponding to the UE.

In a fourth aspect, alone or in combination with one or more of the first through third aspects, each transmission power difference, of the plurality of transmission power differences, is associated with a respective reference signal resource.

In a fifth aspect, alone or in combination with one or more of the first through fourth aspects, the plurality of transmission power differences are associated with a reference signal resource.

In a sixth aspect, alone or in combination with one or more of the first through fifth aspects, one or more first transmission power differences, of the plurality of transmission power differences, are mapped to a single reference signal resource. In some aspects, one or more second transmission power differences, of the plurality of transmission power differences, are mapped to one or more respective reference signal resources.

In a seventh aspect, alone or in combination with one or more of the first through sixth aspects, the CSI report includes a CSI reference signal resource indicator (CRI) which indicates the transmission power difference used to determine the CSI on a reference signal resource associated with the CSI.

In an eighth aspect, alone or in combination with one or more of the first through seventh aspects, the CSI report includes an indicator of the transmission power difference, of the plurality of transmission power differences associated with the reference signal resource, used to determine the CSI on the reference signal resource.

In a ninth aspect, alone or in combination with one or more of the first through eighth aspects, an order of the plurality of transmission power differences in the dynamic indications indicates priorities of CSI reports corresponding to the plurality of transmission power differences.

In a tenth aspect, alone or in combination with one or more of the first through ninth aspects, magnitudes of the plurality of transmission power differences indicate priorities of CSI reports corresponding to the plurality of transmission power differences.

In an eleventh aspect, alone or in combination with one or more of the first through tenth aspects, the reference signal is a CSI reference signal.

In a twelfth aspect, alone or in combination with one or more of the first through eleventh aspects, the dynamic indication is included in a CSI report configuration.

In a thirteenth aspect, alone or in combination with one or more of the first through twelfth aspects, the dynamic indication is based at least in part on at least one of: an uplink received signal power, a target uplink signal-to-interference-and-noise ratio, a self-interference cancellation ratio, a reference signal transmission power in a non-full-duplex zone, or a combination thereof.

In a fourteenth aspect, alone or in combination with one or more of the first through thirteenth aspects, the uplink received signal power is based at least in part on an uplink path loss and a frequency-domain bandwidth of an uplink associated with the base station.

In a fifteenth aspect, alone or in combination with one or more of the first through fourteenth aspects, the target uplink signal-to-interference-and-noise ratio is based at least in part on a buffer status of an uplink associated with the base station.

In a sixteenth aspect, alone or in combination with one or more of the first through fifteenth aspects, the self-interference cancellation ratio is based at least in part on a transmitting beam and a receiving beam of the base station in the full-duplex zone.

In a seventeenth aspect, alone or in combination with one or more of the first through sixteenth aspects, when the transmission power difference pertains to a non-full-duplex zone, the transmission power difference has a value of a static transmission power difference value.

In an eighteenth aspect, alone or in combination with one or more of the first through seventeenth aspects, the dynamic indication includes at least one of: a MAC CE, DCI, or a combination thereof.

In a nineteenth aspect, alone or in combination with one or more of the first through eighteenth aspects, the base station may transmit high-layer signaling identifying a plurality of transmission power differences, where the dynamic indication indicates which transmission power difference, of the plurality of transmission power differences, is to be used to determine the CSI.

In a twentieth aspect, alone or in combination with one or more of the first through nineteenth aspects, the dynamic indication is associated with or included in downlink control information that triggers the determination of the CSI or transmission of the CSI report.

In a twenty-first aspect, alone or in combination with one or more of the first through twentieth aspects, the dynamic indication is included in group-common DCI that is addressed to a radio network temporary identifier (RNTI) associated with the UE.

In a twenty-second aspect, alone or in combination with one or more of the first through twenty-first aspects, the group-common DCI includes a plurality of dynamic indications for a plurality of UEs associated with the RNTI.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

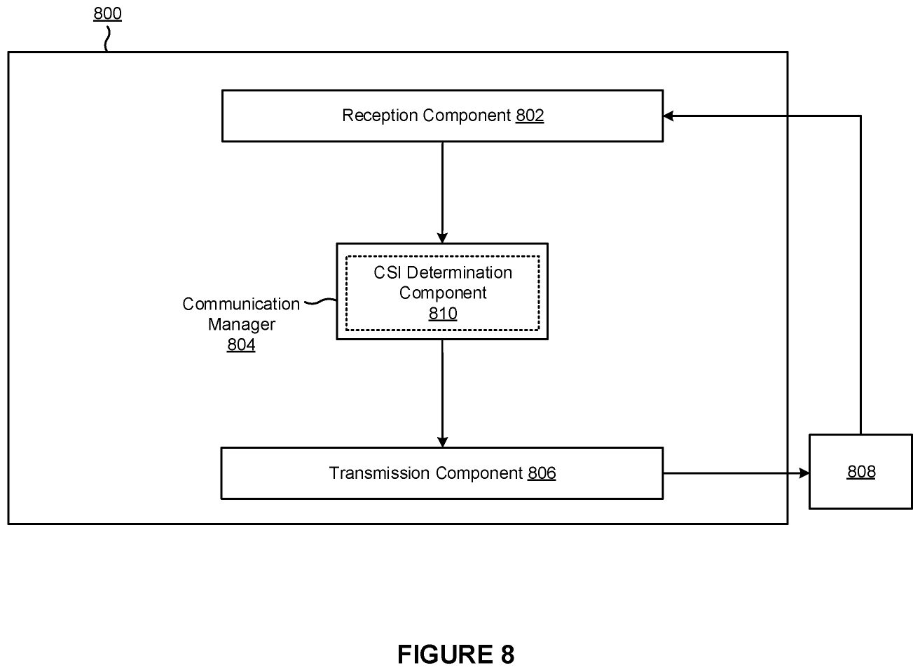

FIG. 8 is a block diagram of an example apparatus 800 for wireless communication. The apparatus 800 may be a UE, or a UE may include the apparatus 800. In some aspects, the apparatus 800 includes a reception component 802, a communication manager 804, and a transmission component 806, which may be in communication with one another (for example, via one or more buses). As shown, the apparatus 800 may communicate with another apparatus 808 (such as a UE, a base station, or another wireless communication device) using the reception component 802 and the transmission component 806.

In some aspects, the apparatus 800 may be configured to perform one or more operations described herein in connection with FIGS. 3-5. Additionally or alternatively, the apparatus 800 may be configured to perform one or more processes described herein, such as process 600 of FIG. 6. In some aspects, the apparatus 800 may include one or more components of the UE described above in connection with FIG. 2.

The reception component 802 may receive communications, such as reference signals, control information, data communications, or a combination thereof, from the apparatus 808. The reception component 802 may provide received communications to one or more other components of the apparatus 800, such as the communication manager 804. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a demodulator, a MIMO detector, a receive processor, a controller/processor, a memory, or a combination thereof, of the UE described above in connection with FIG. 2.

The transmission component 806 may transmit communications, such as reference signals, control information, data communications, or a combination thereof, to the apparatus 808. In some aspects, the communication manager 804 may generate communications and may transmit the generated communications to the transmission component 806 for transmission to the apparatus 808. In some aspects, the transmission component 806 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 806 may include one or more antennas, a modulator, a transmit MIMO processor, a transmit processor, a controller/processor, a memory, or a combination thereof, of the UE described above in connection with FIG. 2. In some aspects, the transmission component 806 may be collocated with the reception component 802 in a transceiver.

The communication manager 804 may receive or may cause the reception component 802 to receive a dynamic indication of a transmission power difference between a reference signal and a downlink shared channel for a full-duplex zone. In some aspects, the communication manager 804 may determine CSI based at least in part on the dynamic indication of the transmission power difference between the reference signal and the downlink shared channel for the full-duplex zone. In some aspects, the communication manager 804 may transmit or may cause the transmission component 806 to transmit a CSI report that identifies the CSI. In some aspects, the communication manager 804 may include a controller/processor, a memory, or a combination thereof, of the UE described above in connection with FIG. 2.

In some aspects, the communication manager 804 may include a set of components, such as a CSI determination component 810. Alternatively, the set of components may be separate and distinct from the communication manager 804. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The CSI determination component 810 may determine CSI based at least in part on a dynamic indication of a transmission power difference between a reference signal and a downlink shared channel for a full-duplex zone. In some aspects, the CSI determination component may determine the CSI in accordance with at least one transmission power difference of a plurality of transmission power differences. For example, the reception component 802 may receive dynamic indications of a plurality of transmission power differences, wherein the plurality of transmission power differences include the transmission power difference, and wherein the plurality of transmission power differences correspond to respective downlink transmission powers, and the CSI determination component may use at least one transmission power difference of the plurality of transmission power differences to determine the CSI. Additionally, or alternatively, the reception component 802 may receive high-layer signaling identifying a plurality of transmission power differences, wherein the dynamic indication indicates which transmission power difference, of the plurality of transmission power differences, is to be used to determine the CSI. In some aspects, the CSI determination component 810 may generate a CSI report that identifies the CSI, and may cause the transmission component 806 to transmit the CSI report.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

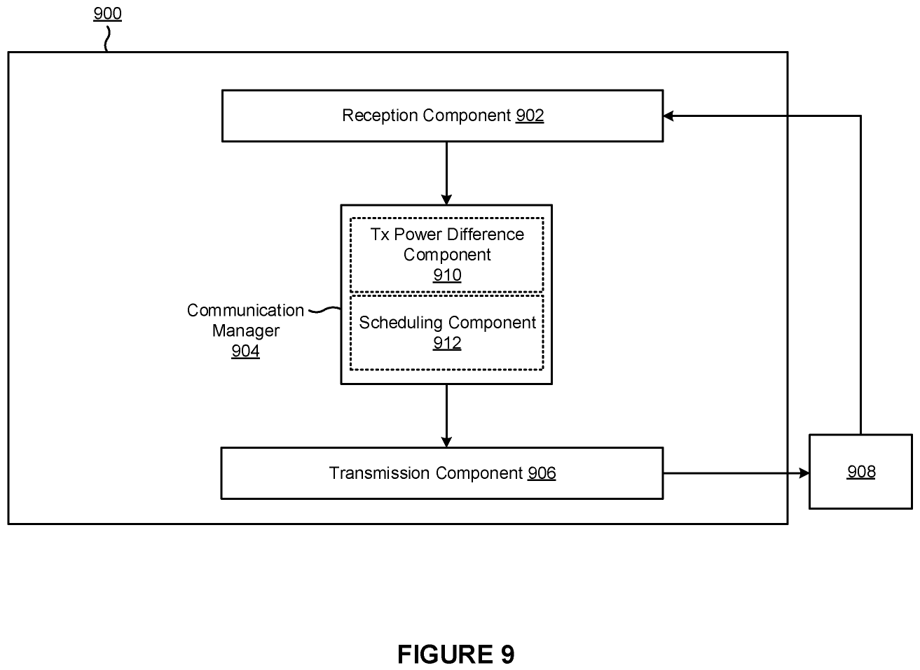

FIG. 9 is a block diagram of an example apparatus 900 for wireless communication. The apparatus 900 may be a base station, or a base station may include the apparatus 900. In some aspects, the apparatus 900 includes a reception component 902, a communication manager 904, and a transmission component 906, which may be in communication with one another (for example, via one or more buses). As shown, the apparatus 900 may communicate with another apparatus 908 (such as a UE, a base station, or another wireless communication device) using the reception component 902 and the transmission component 906.

In some aspects, the apparatus 900 may be configured to perform one or more operations described herein in connection with FIGS. 3-5. Additionally or alternatively, the apparatus 900 may be configured to perform one or more processes described herein, such as process 700 of FIG. 7. In some aspects, the apparatus 900 may include one or more components of the base station described above in connection with FIG. 2.

The reception component 902 may receive communications, such as reference signals, control information, data communications, or a combination thereof, from the apparatus 908. The reception component 902 may provide received communications to one or more other components of the apparatus 900, such as the communication manager 904. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a demodulator, a MIMO detector, a receive processor, a controller/processor, a memory, or a combination thereof, of the base station described above in connection with FIG. 2.

The transmission component 906 may transmit communications, such as reference signals, control information, data communications, or a combination thereof, to the apparatus 908. In some aspects, the communication manager 904 may generate communications and may transmit the generated communications to the transmission component 906 for transmission to the apparatus 908. In some aspects, the transmission component 906 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 906 may include one or more antennas, a modulator, a transmit MIMO processor, a transmit processor, a controller/processor, a memory, or a combination thereof, of the base station described above in connection with FIG. 2. In some aspects, the transmission component 906 may be collocated with the reception component 902 in a transceiver.

The communication manager 904 may determine a transmission power difference between a reference signal and a downlink shared channel for a full-duplex zone. The communication manager 904 may transmit or cause the transmission component 906 to transmit, to a UE, a dynamic indication of the transmission power difference. The communication manager 904 may receive or cause the reception component 902 to receive, from the UE, a CSI report that identifies CSI determined in accordance with the transmission power difference. In some aspects, the communication manager 904 may include a controller/processor, a memory, a scheduler, a communication unit, or a combination thereof, of the base station described above in connection with FIG. 2.

In some aspects, the communication manager 904 may include a set of components, such as a transmit (Tx) power difference component 910, a scheduling component 912, or a combination thereof Alternatively, the set of components may be separate and distinct from the communication manager 904. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The Tx power difference component 910 may determine a transmission power difference between a reference signal and a downlink shared channel for a full-duplex zone, as described elsewhere herein. In some aspects, the Tx power difference component 910 may determine, and may cause the transmission component 906 to transmit, dynamic indications of a plurality of transmission power differences, wherein the plurality of transmission power differences include the transmission power difference, and wherein the plurality of transmission power differences correspond to respective downlink transmission powers. The scheduling component 912 may schedule an uplink communication of a particular UE, of the plurality of UEs, and a downlink communication of the UE in the full-duplex zone based at least in part on CSI associated with a transmission power difference, of the plurality of transmission power differences, corresponding to the UE. In some aspects, the transmission component 906 may transmit high-layer signaling identifying a plurality of transmission power differences, wherein the dynamic indication indicates which transmission power difference, of the plurality of transmission power differences, is to be used to determine the CSI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, or the like, or combinations thereof.

It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein is to be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (for example, related items, unrelated items, a combination of related and unrelated items, or the like, or combinations thereof), and may be used interchangeably with “one or more.” Where only one item is intended, the phrase “only one” or similar language is used. Also, as used herein, the terms “has,” “have,” “having,” or the like, or combinations thereof are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving a dynamic indication of a transmission power difference between a reference signal and a downlink shared channel for a full-duplex zone;
determining channel state information (CSI) based at least in part on the dynamic indication of the transmission power difference between the reference signal and the downlink shared channel for the full-duplex zone; and
transmitting a CSI report that identifies the CSI.

2. The method of claim 1, wherein the reference signal is a CSI reference signal.

3. The method of claim 1, wherein the dynamic indication is included in a CSI report configuration.

4. The method of claim 1, wherein the dynamic indication is based at least in part on at least one of:
an uplink received signal power,
a target uplink signal-to-interference-and-noise ratio,
a self-interference cancellation ratio,
a reference signal transmission power in a non-full-duplex zone, or a combination thereof.

5. The method of claim 1, wherein, when the transmission power difference pertains to a non-full-duplex zone, the transmission power difference has a value of a static transmission power difference value.

6. The method of claim 1, further comprising:
receiving dynamic indications of a plurality of transmission power differences, wherein the plurality of transmission power differences include the transmission power difference, and wherein the plurality of transmission power differences correspond to respective downlink transmission powers, and
wherein determining the CSI further comprises:
determining the CSI in accordance with at least one transmission power difference of the plurality of transmission power differences.

7. The method of claim 6, wherein each transmission power difference, of the plurality of transmission power differences, is associated with a respective reference signal resource.

8. The method of claim 6, wherein the plurality of transmission power differences are associated with a single reference signal resource.

9. The method of claim 6, wherein one or more first transmission power differences, of the plurality of transmission power differences, are mapped to a single reference signal resource, and wherein one or more second transmission power differences, of the plurality of transmission power differences, are mapped to one or more respective reference signal resources.

10. The method of claim 6, wherein the CSI report includes a CSI reference signal resource indicator (CRI) which indicates the transmission power difference used to determine the CSI on a reference signal resource associated with the CSI.

11. The method of claim 6, wherein the CSI report includes an indicator of the transmission power difference, of the plurality of transmission power differences associated with a reference signal resource, used to determine the CSI on the reference signal resource.

12. The method of claim 1, wherein the dynamic indication is associated with or included in downlink control information that triggers the determination of the CSI or transmission of the CSI report.

13. The method of claim 1, wherein the dynamic indication is included in group-common downlink control information (DCI) that is addressed to a radio network temporary identifier (RNTI) associated with the UE, wherein the group-common DCI includes a plurality of dynamic indications for a plurality of UEs associated with the RNTI.

14. A method of wireless communication performed by a base station, comprising:
determining a transmission power difference between a reference signal and a downlink shared channel for a full-duplex zone;
transmitting, to a user equipment (UE), a dynamic indication of the transmission power difference; and
receiving, from the UE, a channel state information (CSI) report that identifies CSI determined in accordance with the transmission power difference.

15. The method of claim 14, further comprising:
transmitting dynamic indications of a plurality of transmission power differences, wherein the plurality of transmission power differences include the transmission power difference, and wherein the plurality of transmission power differences correspond to respective downlink transmission powers, and
wherein the CSI report includes CSI for the plurality of transmission power differences.

16. The method of claim 15, wherein the plurality of transmission power differences correspond to respective uplink communications of a plurality of UEs.

17. The method of claim 16, further comprising:
scheduling an uplink communication of a particular UE, of the plurality of UEs, and a downlink communication of the UE in the full-duplex zone based at least in part on CSI associated with a transmission power difference, of the plurality of transmission power differences, corresponding to the UE.

18. The method of claim 15, wherein each transmission power difference, of the plurality of transmission power differences, is associated with a respective reference signal resource.

19. The method of claim 15, wherein the plurality of transmission power differences are associated with a reference signal resource.

20. The method of claim 15, wherein one or more first transmission power differences, of the plurality of transmission power differences, are mapped to a single reference signal resource, and wherein one or more second transmission power differences, of the plurality of transmission power differences, are mapped to one or more respective reference signal resources.

21. The method of claim 15, wherein the CSI report includes a CSI reference signal resource indicator (CRI) which indicates the transmission power difference used to determine the CSI on a reference signal resource associated with the CSI.

22. The method of claim 21, wherein the CSI report includes an indicator of the transmission power difference, of the plurality of transmission power differences associated with the reference signal resource, used to determine the CSI on the reference signal resource.

23. The method of claim 14, wherein the dynamic indication is based at least in part on at least one of:
an uplink received signal power,
a target uplink signal-to-interference-and-noise ratio,
a self-interference cancellation ratio,
a reference signal transmission power in a non-full-duplex zone, or
a combination thereof.

24. The method of claim 23, wherein the uplink received signal power is based at least in part on an uplink path loss and a frequency-domain bandwidth of an uplink associated with the base station.

25. The method of claim 23, wherein the target uplink signal-to-interference-and-noise ratio is based at least in part on a buffer status of an uplink associated with the base station.

26. The method of claim 23, wherein the self-interference cancellation ratio is based at least in part on a transmitting beam and a receiving beam of the base station in the full-duplex zone.

27. The method of claim 14, wherein, when the transmission power difference pertains to a non-full-duplex zone, the transmission power difference has a value of a static transmission power difference value.

28. The method of claim 14, further comprising:
transmitting high-layer signaling identifying a plurality of transmission power differences, wherein the dynamic indication indicates which transmission power difference, of the plurality of transmission power differences, is to be used to determine the CSI.

29. A user equipment (UE) for wireless communication, comprising:
a memory; and
one or more processors operatively coupled to the memory, the memory and the one or more processors configured to:
receive a dynamic indication of a transmission power difference between a reference signal and a downlink shared channel for a full-duplex zone;
determine channel state information (CSI) based at least in part on the dynamic indication of the transmission power difference between the reference signal and the downlink shared channel for the full-duplex zone; and
transmit a CSI report that identifies the CSI.

30. A base station for wireless communication, comprising:
a memory; and
one or more processors operatively coupled to the memory, the memory and the one or more processors configured to:
determine a transmission power difference between a reference signal and a downlink shared channel for a full-duplex zone;
transmit, to a user equipment (UE), a dynamic indication of the transmission power difference; and
receive, from the UE, a channel state information (CSI) report that identifies CSI determined in accordance with the transmission power difference.
